(19) United States
(12) Patent Application Publication
(10) Pub. No.: US 2025/0232593 A1
(43) Pub. Date: Jul. 17, 2025

(54) HIT-AND-RUN DETECTION FOR VEHICLES

(71) Applicant: Rivian IP Holdings, LLC, Irvine, CA (US)

(72) Inventors: Aruna BAIJAL, Sunnyvale, CA (US); Saloni Chaturdas TAKAWALE, Sunnyvale, CA (US); Zengli YANG, Cupertino, CA (US)

(21) Appl. No.: 18/415,541

(22) Filed: Jan. 17, 2024

(51) Int. Cl. G06V 20/58; B60R 1/12; B60R 1/22; G06V 10/764; G06V 10/82; G06V 20/62

(52) U.S. Cl. CPC G06V 20/58; B60R 1/12; B60R 1/22; G06V 10/764; G06V 10/82; G06V 20/625; B60R 2001/1253; G06V 2201/08

(57) ABSTRACT

Aspects of the disclosure relate to detection and recording of actual or potential impacts to parked vehicle, including hit-and-run incidents involving the parked vehicle and a moving vehicle. For example, using a camera of a parked vehicle having motion sensors that are in a sleep state or other inactive state, the parked vehicle may determine that a moving object, other than a person, is within a threshold distance of the parked vehicle. The parked vehicle may then capture at least one image using at least the camera of the parked vehicle. In this way, the parked vehicle can use its own cameras to detect and document a potential or actual impact on the parked vehicle by the moving object.

### INTRODUCTION

Vehicles are often provided with backup cameras that allow a driver to view the environment behind the vehicle, particularly when operating the vehicle in reverse. Some vehicles include multiple cameras to provide the driver with multiple views of the environment.

### SUMMARY

Aspects of the subject disclosure relate to camera-based (e.g., vision-based) detection and recording of video of impacts to a vehicle while the vehicle is parked. This can be particularly helpful in the case of a hit-and-run incident in a parking lot, parking garage, or other parking area, and can be effective when other sensors of the vehicle are in a sleep state or other inactive state. A detection process for triggering recording of video of impacts while the vehicle is parked can be a power conserving process that includes a set of staged triggers in one or more implementations. For example, the staged triggers can include detection of a vehicle in a camera image, which may trigger a determination of whether the detected vehicle is within a threshold distance of the parked vehicle, which may trigger a determination of whether the detected vehicle within the threshold distance is moving, which may trigger video recording (e.g., including a during a lookback time of, for example, several seconds before video recording was triggered).

In accordance with aspects of the subject technology, an apparatus is provided that includes a plurality of cameras, each camera having a field of view that includes a respective portion of an external environment of the apparatus; and processing circuitry configured to initiate recording of a video of the external environment using the plurality of cameras based on: a detection of a vehicle in at least one image from at least one of the plurality of cameras; a determination that at least a portion of the vehicle is within a threshold distance of the apparatus; and a determination that the vehicle that is within the threshold distance of the apparatus is moving. The plurality of cameras and the processing circuitry may be implemented in another vehicle that is parked, and the processing circuitry may be configured to initiate the recording of the video of the external environment to capture a hit-and-run incident involving the vehicle.

The processing circuitry may be configured to detect the vehicle in the at least one image by: providing the at least one image to a neural network that has been trained to detect at least vehicles in images; and detecting the vehicle based on an output of the neural network. Detecting the vehicle may include determining that the vehicle is not a person. The output of the neural network may include a bounding box corresponding to an object in the at least one image, a classification of the object as the vehicle, and an object identifier associated with the object.

The processing circuitry may be configured to determine that at least the portion of the vehicle is within the threshold distance of the apparatus by transforming a location in the at least one image that corresponds to the at least the portion of the vehicle into a physical location in the external environment, using one or more known parameters of the at least one of the plurality of cameras. The location in the at least one image that corresponds to the at least the portion of the vehicle may include a predetermined location on the bounding box.

The processing circuitry may be configured to determine that the vehicle that is within the threshold distance of the apparatus is moving based on multiple detections of the object having the object identifier in multiple images from one or more of the plurality of cameras. The neural network may be configured to output multiple bounding boxes, including the bounding box, for the multiple detections of the object, and the processing circuitry may be configured to determine that the vehicle that is within the threshold distance of the apparatus is moving based on a change in location of the bounding box. The neural network may be configured to output multiple bounding boxes, including the bounding box, for the multiple detections of the object, and the processing circuitry may be configured to determine that the vehicle that is within the threshold distance of the apparatus is moving based on a change in a shape of the bounding box.

The at least one of the plurality of cameras may be mounted to a side mirror of a vehicle, and transforming the location in the at least one image that corresponds to the at least the portion of the vehicle into the physical location in the external environment using the one or more known parameters of the at least one of the plurality of cameras may include transforming the location in the at least one image that corresponds to the at least the portion of the vehicle into the physical location in the external environment using the one or more known parameters of the at least one of the plurality of cameras and based on a determination of whether the side mirror of the vehicle is in a folded position or an extended position.

In accordance with other aspects of the subject technology, a method is provided that includes detecting a vehicle in at least one image from at least one of a plurality of cameras that are mounted to an apparatus; determining, responsive to detecting the vehicle, that at least a portion of the vehicle is within a threshold distance of the apparatus; determining, responsive to determining that at least the portion of the vehicle is within the threshold distance of the apparatus, that the vehicle that is within the threshold distance of the apparatus is moving; and initiating, responsive to determining that the vehicle that is within the threshold distance of the apparatus is moving, recording of a video of an external environment of the apparatus using the plurality of cameras. Detecting the vehicle in the at least one image may include providing the at least one image to a neural network that has been trained to detect at least vehicles in images; and detecting the vehicle based on an output of the neural network.

Determining that at least the portion of the vehicle is within the threshold distance of the apparatus may include transforming a location in the at least one image that corresponds to the at least the portion of the vehicle into a physical location in the external environment using one or more known parameters of the at least one of the plurality of cameras. The output of the neural network may include a bounding box corresponding to an object in the at least one image, a classification of the object as the vehicle, and an object identifier associated with the object, and the location in the at least one image that corresponds to the at least the portion of the vehicle may include a predetermined location on the bounding box.

Determining that the vehicle that is within the threshold distance of the apparatus is moving may include determining that the vehicle that is within the threshold distance of the apparatus is moving based on multiple detections of the object having the object identifier in multiple images from one or more of the plurality of cameras.

In accordance with other aspects of the disclosure, a method is provided that includes determining, using a camera of a parked vehicle having motion sensors that are in a sleep state, that a moving object other than a person is within a threshold distance of the parked vehicle; and capturing at least one image using at least the camera of the parked vehicle responsive to the determining, to document a potential impact on the parked vehicle by the moving object. Capturing the at least one image may include capturing an image of an identifier of the moving object. The moving object may include a moving vehicle and the identifier of the object may include a license plate of the moving vehicle.

The parked vehicle may also include proximity sensors that are in the sleep state, and the method may also include determining, using the camera of the parked vehicle having the motion sensors and the proximity sensors that are in the sleep state, that the moving object other than the person is within the threshold distance of the parked vehicle by performing a geometric determination of a location of the moving object without identifying individual features of the object.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle having cameras in accordance with one or more implementations.

FIG. 2 illustrates a schematic top view of a vehicle having cameras in accordance with one or more implementations.

FIG. 3 illustrates a schematic top view of a vehicle at a time when another vehicle is within a threshold distance of the vehicle in accordance with one or more implementations.

FIG. 4 illustrates an example image that may be captured by a camera of a vehicle in accordance with one or more implementations.

FIG. 5 illustrates a schematic diagram of a processing architecture for detecting and recording an impact to a vehicle in accordance with one or more implementations.

FIG. 6 a schematic top view of a vehicle having cameras on folded side mirrors in accordance with one or more implementations.

FIG. 7 illustrates a flow chart of illustrative operations that may be performed for recording a potential or actual impact to a vehicle in accordance with one or more implementations.

FIG. 8 illustrates a flow chart of other illustrative operations that may be performed for recording a potential or actual impact to a vehicle in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Vehicles are left parked in parking lots, parking garages, and along streets, sometimes for hours or days at a time. A frustration among vehicle owners is damage to a vehicle that occurs while the vehicle is parked and the owner is away from the vehicle, such as when the parked vehicle is impacted by another vehicle. In these instances, there is often no record of the impact and no way for the vehicle owner to find the other vehicle that caused the damage. One option for capturing information about an impact and/or the other vehicle that caused the impact is to capture images of the other vehicle using the vehicle's cameras.

However, it can be inefficient or impossible to constantly record and store video from all cameras of a vehicle. Accordingly, it can be helpful to be able to detect an impact, and/or to generate another trigger for recording and/or storing camera images and/or video when an impact has occurred, or is about to occur. However, even in vehicles with sensors, such as proximity sensors and/or motion sensors, that can detect an impact and trigger recording, it can be challenging to generate a recording trigger when such sensors are in an inactive or off state when the vehicle is parked.

Aspects of the subject technology can provide an image-based (e.g., vision based) system for detecting a potential or actual impact to a parked vehicle, and trigger recording of images and/or video of the impact responsive to the detection. Further details are provided hereinafter.

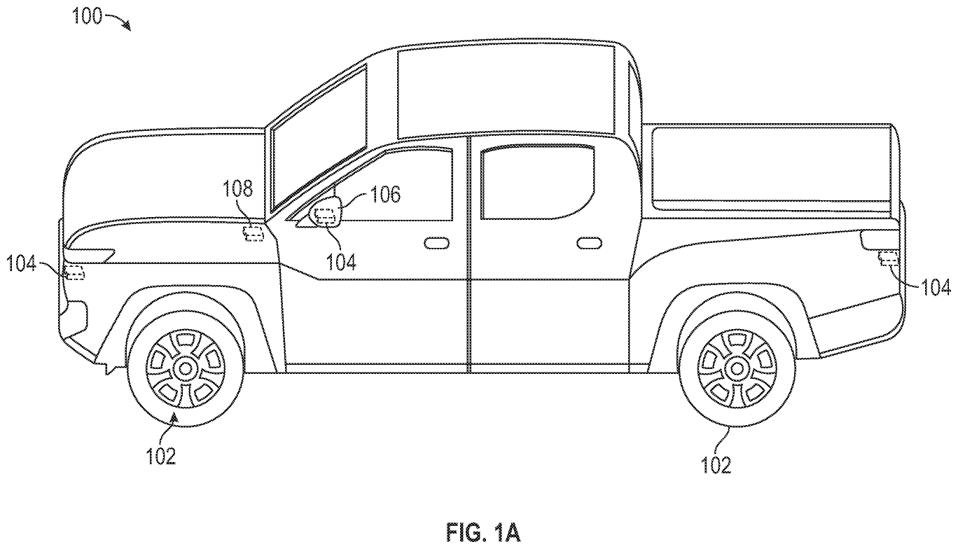

FIG. 1A is a diagram illustrating an example implementation of an apparatus as described herein. In the example of FIG. 1A, the apparatus is a moveable apparatus implemented as a vehicle 100. In one or more implementations, the vehicle 100 may be implemented as an electric vehicle and may include one or more batteries for powering the vehicle and/or one or more systems and/or components of the vehicle.

For example, in one or more implementations, the vehicle 100 may be an electric vehicle having one or more electric motors that drive the wheels 102 of the vehicle using electric power from the battery. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid).

In the example of FIG. 1A, the vehicle 100 is implemented as a truck (e.g., a pickup truck) having one or more cameras 104, and processing circuitry 108 (e.g., one or more processors, memory, and/or communications circuitry). As shown, the vehicle 100 may include multiple cameras 104 spaced apart around the exterior of the vehicle 100, such as for capturing images of the environment around the vehicle. In the example of FIG. 1A, the vehicle 100 includes a camera 104 at or near the front of the vehicle, a camera 104 at or near a rear of the vehicle 100, and/or camera(s) 104 on one or more sides of the vehicle. For example, a camera 104 may be disposed in each of one or more side mirrors 106 of the vehicle 100 in some implementations.

As examples, the processing circuitry 108 of the vehicle 100 may include one or more processors (e.g., single processors, multi-core processors, central processing units (CPUs), application-specific integrated circuits (ASICS), field programmable gate arrays (FPGAs) and/or other processing circuits), and/or any of various types of computer-readable and/or machine-readable media (e.g., persistent storage, system memory and/or buffers, volatile memory and/or non-volatile memory). In one or more implementations, the processing circuitry 108 may include input devices, output devices, network interfaces, and/or a bus that communicatively couples the processor(s), the memory, the communications circuitry, the input devices, the output devices, and/or one or more other devices or components (e.g., cameras 104, motion sensors, proximity sensors, etc.). The processor(s) of the processing circuitry 108 may execute instructions stored in the memory of the processing circuitry 108, such as to execute one or more machine learning models (e.g., neural networks, such as deep learning networks, transformer-based models and/or other attention-based models, multi-layer perceptrons or other feed-forward networks) and/or other hardware, firmware, and/or software processes in order to perform the processes of the subject disclosure.

The example of FIG. 1A, in which the vehicle 100 is implemented as a pickup truck having a truck bed, is merely illustrative. For example, FIG. 1B illustrates another implementation in which the vehicle 100 including the cameras 104 and the processing circuitry 108 is implemented as a sport utility vehicle (SUV), such as an electric sport utility vehicle. In the example of FIG. 1B, the vehicle 100 including the cameras 104 and the processing circuitry 108 may include a cargo storage area in at least a rear portion of the vehicle that is enclosed within the vehicle 100 (e.g., behind a row of seats within a cabin of the vehicle). In other implementations, the vehicle 100 may implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, and/or any other movable apparatus having cameras 104 and the processing circuitry 108.

In one or more implementations, the cameras 104 and the processing circuitry 108 as described herein may also, or alternatively, be implemented in another apparatus, such as a building (e.g., a residential home or commercial building, or any other building) or other stationary apparatus.

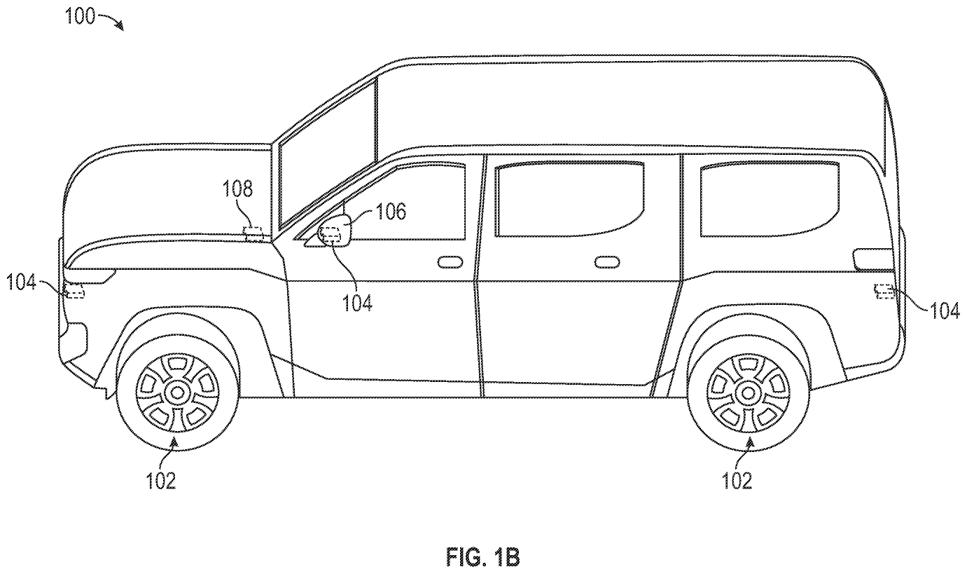

FIG. 2 depicts a top view of the vehicle 100 in accordance with one or more implementations. As shown in FIG. 2, the vehicle 100 may include multiple cameras 104, each camera having a field of view 208 that includes a respective portion of an external environment 204 of the vehicle 100. For example, a camera 104 located at or near a front of the vehicle 100 may have a field of view 208 that includes a portion of the external environment 204 in front of the vehicle 100. A camera 104 located at or near a rear of the vehicle 100 may have a field of view 208 that includes a portion of the external environment 204 behind the vehicle 100. Cameras 104 located on each side (e.g., a left side and a right side) of the vehicle 100, such as mounted in the side mirrors 106 on either side of the vehicle 100 (or elsewhere, such as in a door panel or other side panel or component), may have a fields of view 208 that include respective portions of the external environment 204 on each side of the vehicle 100. Although four cameras are depicted in FIG. 2, this is merely illustrative and, in other implementations, less than four, or more than four cameras can be provided at various locations around the vehicle 100.

As shown, each of the cameras 104 may include one or more lenses 210. For example, the lenses 210 may be wide-angle lenses, such as fisheye lenses, and may distort the view of the external environment 204 by the cameras 104 in some implementations. The lenses 210 may be arranged to focus light from the external environment 204 within the respective fields of view 208 onto one or more image sensors (e.g., charge coupled device (CCD) image sensors, complementary metal-oxide-semiconductor (CMOS), visible light image sensors, infrared image sensors, and/or other image sensors). As indicated in FIG. 2, the processing circuitry 108 may communicate with the cameras 104, such as by providing control signals to the cameras 104 to control the operation of the cameras 104, and/or by receiving images and/or image data captured by the cameras 104.

As shown in FIG. 2, the vehicle 100 may include sensors other than the cameras 104, such as one or more motion sensors 200 and/or one or more proximity sensors 202. For example, motion sensors 200 may be implemented as inertial sensors, such as inertial measurement units (IMUs), which may include one or more accelerometers, one or more gyroscopes, and/or one or more magnetometers. For example, proximity sensors 202 may include a light source, such as an infrared or radar light source, and a sensor that determines proximity of an object based on reflections of the emitted signals from the light source.

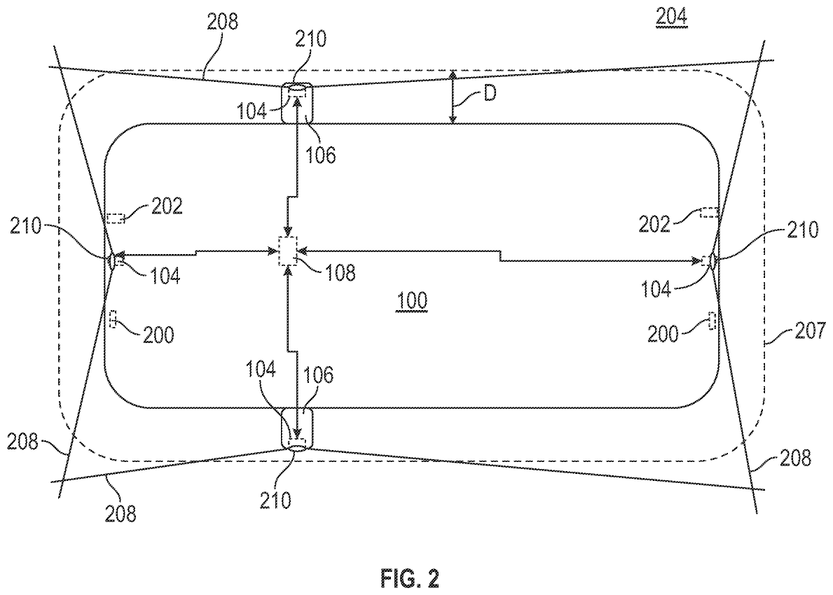

FIG. 3 illustrates an example use case in which a vehicle 300 crosses a boundary 207, and moves within a threshold distance, D, of the vehicle 100. The example of FIG. 3 may occur when the vehicle 100 is parked, and is in an off state, sleep state, or other inactive state. For example, in the off state, sleep state, or other inactive state, sensors, such as motion sensors 200 and/or proximity sensors 202, may be in an off state, a sleep state, or another inactive state (e.g., may be powered down and/or may not be providing sensor data to the processing circuitry 108). As shown in FIG. 3, the vehicle 300 (also referred to herein as an “other” vehicle 300 in some examples) may have a vehicle identifier 304. As examples, the vehicle identifier 304 may include a make, a model, a license plate number, a vehicle identification number (VIN), and/or other identifiers such as stickers, modifications or the like. For example, the vehicle identifier 304 may be a physical identifier that would be visible to one or more of the cameras 104 and/or the human eye if the vehicle 300 is within the field of view thereof.

In the example of FIG. 3, the processing circuitry 108 may be configured to initiate recording of a video of the external environment 204 using the multiple cameras 104, based on image data or vision data obtained using the camera(s) 104 (e.g., without using sensor data from motion sensors 200 or proximity sensors 202, in some implementations). For example, the processing circuitry 108 may be configured to initiate recording of a video of the external environment 204 using the multiple cameras 104 based on: a detection of another vehicle 300 in at least one image from at least one of the multiple cameras 104; a determination that at least a portion of the other vehicle 300 is within a threshold distance, D, of the vehicle 100; and a determination that the other vehicle 300 that is within the threshold distance, D, of the vehicle 100 is moving (e.g., as indicated in FIG. 3 by a motion vector 302). For example, the threshold distance, D, may define the boundary 207 around the vehicle 100, within which detection of a moving vehicle triggers capture of images and/or video of the external environment 204.

For example, the cameras 104 and the processing circuitry 108 may be implemented in a vehicle 100 that is parked (e.g., and turned off or in a sleep mode or other inactive mode), and the processing circuitry 108 may be configured to initiate the recording of the video of the external environment 204 to capture an impact to the vehicle 100, such as a hit-and-run incident involving the other vehicle 300.

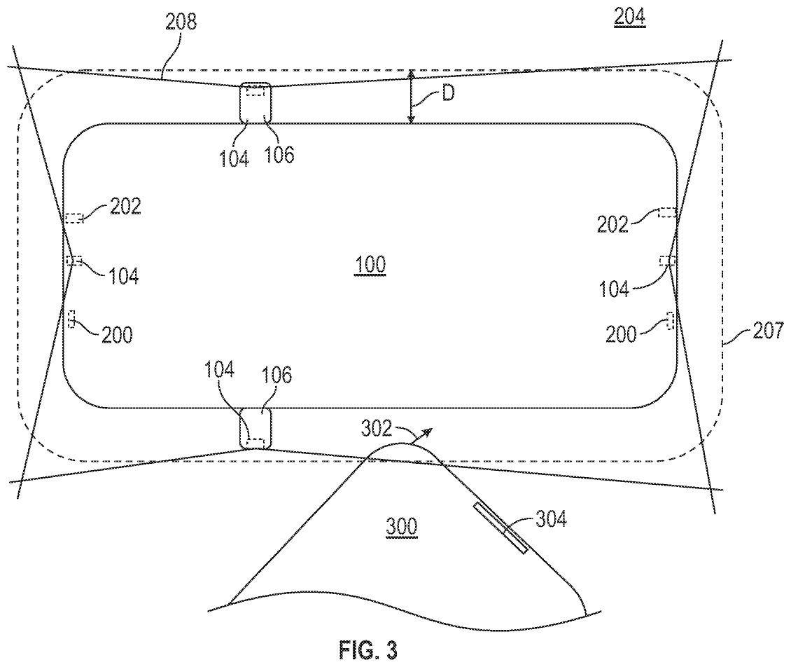

For example, FIG. 4 illustrates an example of an image 400 that may be captured by one of the cameras 104 of the vehicle 100. In the example of FIG. 4, the image 400 has the characteristic distortion of an image captured through a fisheye or other wide-angle lens, however, this is merely illustrative and other lenses/projections can be used. In the example of FIG. 3, the vehicle 300 can be seen in the image 400. In this example, another vehicle 406 can also be seen in the image 400 at a further distance than the vehicle 300.

As shown, a portion of the image corresponding to each vehicle detected in the image may be identified (e.g., by the processing circuitry 108). In the example of FIG. 4, the processing circuitry 108 has identified a bounding box 404 corresponding to the vehicle 300, and a bounding box 405 corresponding to the vehicle 406. For example, a bounding box may be a set of image pixel locations that defined a (e.g., closed) boundary within an image. As shown, the bounding boxes 404 and 405 may enclose the images of the vehicle 300 and the vehicle 406, respectively. As shown, the processing circuitry 108 may also generate attribute information 414 for each detected vehicle. For example, the attribute information 414 may include a classification (e.g., CLASS1 and CLASS2 for vehicle 300 and vehicle 406, respectively) of one or more objects detected in the image 400, a confidence (e.g., CONF1 and CONF2 for vehicle 300 and vehicle 406, respectively) for each classification, and an object identifier (e.g., ID1 and ID2 for vehicle 300 and vehicle 406, respectively) associated with each detected object in an image.

For example, the classification of an object in the image 400 may be a classification of the object as a person, an animal, a vehicle, or a specific type of vehicle (e.g., a car, a truck, a bus, a bicycle, a train, or a motorcycle). In the example of FIG. 4, each of CLASS1 and CLASS2 may be indications that the detected object is a vehicle or a car. In the example of FIG. 4, the attribute information 414 and the bounding boxes 404 and 404 are displayed over the image 400 for illustrative purposes. However, it is appreciated that an image with overlaid bounding boxes and/or attribute information need not be generated by the processing circuitry 108, and the bounding boxes 404 and 405 and their respective attribute information 414 can be generated and/or stored by the processing circuitry 108 based on the image 400 without generating a visual representation thereof. In one or more implementations, the attribute information 414 for each detected object may be stored as metadata of a bounding box for that object.

In one or more implementations, the vehicle 100 (e.g., the processing circuitry 108) may determine that at least a portion of the vehicle 300 that has been identified in the image 400 is within the threshold distance, D, of the vehicle 100, at least in part by transforming a location in the image 400 that corresponds to vehicle 300 into a physical location in the external environment 204. For example, the transformation may be performed using one or more known parameters (e.g., camera parameters) of the cameras 104. For example, the known parameters for each camera 104 may include the location of the camera 104 with respect to the vehicle 100 (e.g., with respect to a reference frame that is fixed to the vehicle 100), the orientation of the camera 104 with respect to the vehicle 100, lens characteristics of the lens(es) 210 of the camera 104, and/or other calibration information for the camera 104. The parameters of the camera 104 may be predetermined (e.g., during manufacturing of the vehicle 100, periodically during the lifetime of the vehicle 100, or upon startup or shutdown of the vehicle 100) prior to detecting the vehicle 300 in the image 400.

In one or more implementations, the location in the image 400 that is transformed into a physical location in the external environment 204 may be a specific feature of the vehicle (e.g., corner, a bumper, a door, a side mirror, etc.) or may be a predetermined location on the bounding box for that vehicle. For example, in FIG. 4, a predetermined location 408 (e.g., a bottom center) of the bounding box 404 (e.g., on the perimeter of the bounding box) may be transformed into the physical location in the external environment 204 to determine the distance of the predetermined location 408 from the vehicle 100.

For example, if it is determined that the physical location in the external environment that corresponds to the predetermined location 408 in the image 400 is within the threshold distance, D, from the vehicle 100, the vehicle 100 (e.g., the processing circuitry 108) may determine whether the vehicle 300 is moving. For example, determining whether the vehicle 300 is moving may include identifying (e.g., in multiple images of the vehicle taken over time, such as multiple video frames) a change in the location of the bounding box 404 and/or a change in the shape of the bounding box 404. For example, if the vehicle 300 is driving, a change in the location of the bounding box 404 may be identified by identifying motion (e.g., a motion vector 410) of the bounding box 404 (e.g., corresponding to the physical motion vector 302 of the vehicle 300) and therefore of the predetermined location 408 (e.g., either in the image space of image 400 or in the transformed physical space of the external environment), across multiple image frames captured by the camera 104 that captured the image 400. However, the vehicle 300 can also impact the vehicle 100 without driving, such as by an opening of a door of the vehicle 300 into the vehicle 100. For example, if the door of the vehicle 300 is being opened, the shape of the bounding box 404 may change (e.g., an extension 412 of the bounding box 404 may form a wider bounding box 411), causing a change in the predetermined location 408 (e.g., either in the image space of image 400 or in the transformed physical space of the external environment), such as the bottom center of the bounding box 404, across multiple image frames captured by the camera 104 that captured the image 400. In this way, an opening of the door of the vehicle 300, or another change in the shape of the vehicle 300, can also be detected as motion of the vehicle 300, based on a change in the predetermined location 408 across multiple image frames captured by the camera 104.

If it is determined (e.g., by the processing circuitry 108) that an object detected in an image 400 is a vehicle (e.g., not a person), is within the threshold distance, D, and is moving, the processing circuitry 108 may initiate recording of video of the external environment 204. The processing circuitry 108 may initiate recording of video of the external environment 204 using the camera 104 that captured the image 400, and/or one or more additional cameras 104 (e.g., all cameras 104) of the vehicle 100. The processing circuitry 108 may initiate recording of video of the external environment 204 at the time at which the vehicle 300 is detected within the boundary 207, or at an earlier time (e.g., one, two, three, or several seconds) before the detection, and may continue recording while the vehicle 300 is within the boundary 207. For example, the processing circuitry 108 may continuously buffer one, two, three, or several seconds of video frames from the camera(s) 104, and may move or copy the buffered one, two, three, or several seconds of video frames to permanent storage (along with additional incoming video frames) when a moving vehicle is detected within the boundary 207 (e.g., within the threshold distance, D, of the vehicle).

In one or more implementations, the processing circuitry 108 may adjust the recording of video of the external environment 204 (e.g., by adjusting which cameras capture images, adjusting the positions and/or orientations of one or more cameras, and/or adjusting the time during which recording occurs) to capture, in the video, a way to identify the vehicle 300. For example, the processing circuitry 108 may continue and/or otherwise adjust the recording of video by the cameras 104 until a vehicle identifier (e.g., vehicle identifier 304, such as a license plate, a VIN number, a make, a model, or other identifier) is detected in one or more images (e.g., video frames), and/or until the vehicle 300 is no longer detected in the images/video frames.

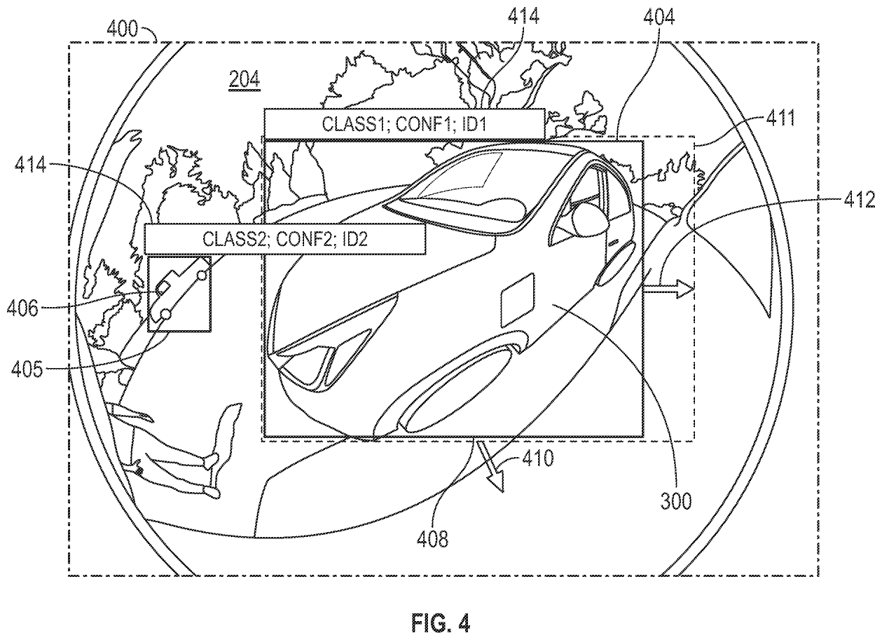

FIG. 5 illustrates an example processing architecture for performing one or more of the operations described herein, such as for detecting an actual or potential impact to a vehicle, and/or initiating recording of the actual or potential impact. The operations described in connection with FIG. 5 may be performed by the processing circuitry 108 of the vehicle 100. For example, as shown in FIG. 5, one or more images 400 may be provided to an object detector 502. For example, the object detector 502 may be implemented as a neural network that has been trained to classify objects in images responsive to receiving the images as input. For example, the object detector 502 may have been trained to identify a person, a vehicle, and/or a specific type of vehicle, such as a car, a truck, a bicycle, a bus, a train, a motorcycle, or other type of vehicle. In one or more use cases, when a person is detected in the image 400 by the object detector 502, a separate process from that described herein, may be performed for determining whether to capture images of the person.

As shown, one or more of the images 400 may also be temporarily stored in a buffer 501. For example, the buffer 501 may be configured to store between one and ten seconds of video frames. In a scenario in which the detected vehicle is determined to be within the threshold distance of the vehicle 100 and is determined to be in motion, some or all of the video frames in the buffer 501 may be permanently stored (e.g., as a lookback portion of a video that also includes additional incoming video frames captured after the detection of the vehicle).

As illustrated in FIG. 5, when a vehicle (e.g., any of the specific types of vehicles, such as the vehicle 300 of FIGS. 3 and 4) is detected by object detector 502, the object detector 502 may output detected-vehicle information, such as a bounding box 404 for the detected vehicle. As discussed above in connection with FIG. 4, the detected-vehicle information (e.g., the bounding box 404) may include a boundary around the detected vehicle in the image 400 and/or additional information, such as attribute information 414 (e.g., including an identifier of the image of the detected vehicle).

As shown, the output (e.g., detected vehicle information, such as bounding box 404, also referenced as BB in the figure) of the object detector 502 may be provided to a sensing block 506 (also referenced as SB in the figure) and a multi-object tracking block 519 (also referenced as MO-T in the figure). For example, the multi-object tracking block 519 (e.g., a Simple Online and Realtime Tracking (SORT) based tracker or other multi-object tracker) may store the bounding box information for each of one or more (e.g., multiple) detected objects, including the detected vehicle, for a period of time, such as over a past one second or several seconds. In this way, tracking information, over the period of time, for detected vehicles may be available for motion analysis if a vehicle is detected within the threshold distance, D, by the sensing block 506.

As shown, in addition to receiving the detected-vehicle information (e.g., bounding box 404), the sensing block 506 may also receive and/or have access to calibration information, such as camera parameters 512 (e.g., also referenced as CP in the figure). For example, the camera parameters 512 may include, for each of the cameras 104 of the vehicle 100, transformation information for transforming an image space of the camera (and/or a location within the image space) to a physical space (and/or a location within the physical space) of the external environment 204 of the vehicle. The camera parameters 512 may also, or alternatively include information for deriving the transformation information, such as a location, an orientation, lens properties, and/or other attributes of the camera). In one or more implementations, the camera parameters 512 may include, for each camera 104, a look-up table of physical locations in the external environment 204 that correspond to each of the pixels of that camera 104. In these example implementations, the transformations may be obtained without performing the computations of the transformation during the determination of whether the detected vehicle is within the threshold distance, D (e.g., by utilizing a previously computed transformation). The physical locations resulting from the transformation may be expressed as coordinates in a three-dimensional or two-dimensional space, or may be expressed as physical distances from the body of the vehicle 100.

In the expanded view of sensing block 506 in FIG. 5, a particular location 408 (e.g., the bottom center or another location) on the bounding box 404 can be provided to a transformation block 516. The transformation block 516 (also referenced as TRANSF in the figure) may determine (e.g., may look up in the lookup table of pixel to physical space transformations) a physical location 518 in the external environment 204 based on the particular location 408 in image space and the camera parameters 512. As shown, the sensing block 506 may include a boundary checker 520 (also referenced as BOUND in the figure) that determines whether the physical location 518 is within a predetermined distance, D, (e.g., within the boundary 207) of the vehicle 100. As shown, an output 521 of the boundary checker 520 may be provided to a motion detection block 508 (also referenced as MDB in the figure). For example, the output 521 may be a binary indicator of whether the detected vehicle (e.g., vehicle 300) is inside the boundary 207 or not inside the boundary 207.

As indicated in FIG. 5, if the output 521 of the sensing block 506 (e.g., the output 521 of the boundary checker 520) indicates that the detected vehicle is inside the boundary 207 (e.g., within the threshold distance, D), the motion detection block 508 may perform motion detection operations for the detected vehicle. If the detected vehicle is not inside the boundary 207, the motion detection operations of the motion detection block 508 may not be performed in some implementations.

As indicated in the expanded view of motion detection block 508, the motion detection block 508 may obtain a location history 522 (e.g., a bounding box history of the bounding box 404, the location history also referenced as LH in the figure) for the detected vehicle that has been determined, by the sensing block 506, to be within the boundary 207 (e.g., within the threshold distance, D). For example, the location history 522 may be obtained, for the detected vehicle that has been determined to be within the boundary 207, from multiple location histories of multiple detected objects generated and/or stored by the multi-object tracking block 519.

As shown, the motion detection block 508 may include a frame group motion detector 524 (also referenced as FGMD in the figure), and a motion confirmation block 525 (also referenced as MCB in the figure). For example, the frame group motion detector 524 may determine whether the bounding box 404 has moved or changed shape (e.g., by detection of a change in the particular location 408 on the bounding box 404 by more than a motion threshold) across two or more frames (e.g., a pair of video frames, such as adjacent video frames). In order, for example, to avoid false positives and confirm the detected motion, the motion confirmation block 525 may determine whether the motion and/or change of the bounding box 404 is greater than the motion threshold (e.g., a threshold number of pixels in image space) in at least a threshold number of frame groups (e.g., frame pairs) within a time period. For example, the threshold number of frame groups may be two frame groups (e.g., two frame pairs), three frame groups (e.g., three frame pairs), four frame groups (e.g., four frame pairs) or another number of frame groups from a set of video frames (image frames) captured during the time period (e.g., the last one second or several seconds).

If the motion detection block 508 determines that the detected vehicle that has been determined to be within the boundary 207 is moving (e.g., based on a determination by the motion confirmation block 525 that the motion and/or change of the bounding box 404 is greater than the motion threshold in at least the threshold number of frame groups), the motion detection block 508 may generate an output 526 that triggers recording 510 of video (e.g., including during a lookback period of time before the detection, using the buffered images in the buffer 501) by one or more (e.g., all) cameras 104 of the vehicle 100. As shown, the recorded video may be stored in video storage 530 (e.g., locally in memory of the vehicle 100 and/or at a remote device, such as a cloud server).

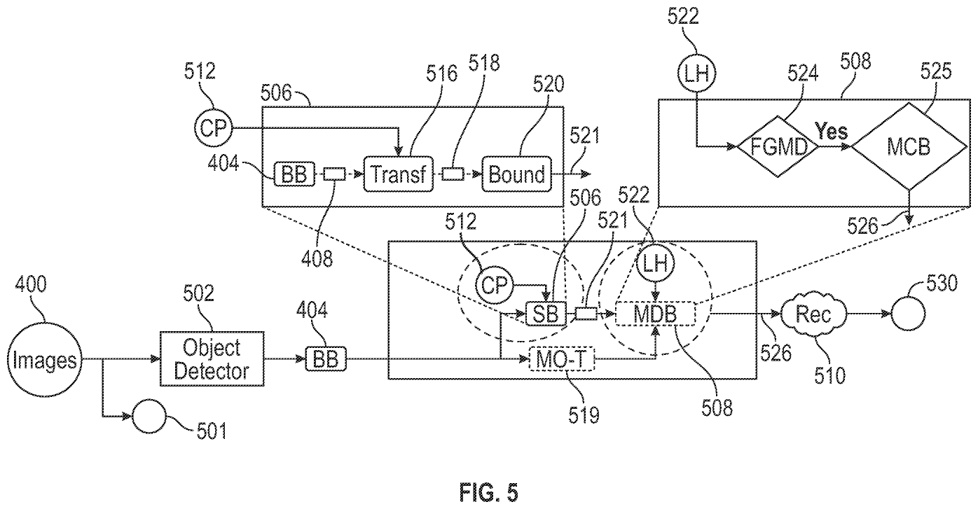

In the examples described herein in connection with FIGS. 3-5, the camera calibration parameters (e.g., camera parameters 512) are used to perform a geometric transformation or other geometric mapping of a location in an image space of a camera 104 to a physical location in the external environment 204 of the vehicle 100. In one or more implementations, one or more of the cameras 104 may change their location, position, and/or orientation in various modes of the vehicle 100. For example, FIG. 6 illustrates an implementation in which the vehicle 100 has foldable side mirrors 106 in which cameras 104 are disposed. In the example of FIG. 6, the side mirrors 106 have been folded in, relative to the extended configuration of the side mirrors shown in FIG. 3. As illustrated in FIG. 6, this change in the vehicle configuration (e.g., to fold in the side mirrors 106) can change the fields of view 208 of some of the cameras 104 (e.g., the cameras 104 disposed in the side mirrors 106).

Referring back to FIG. 5, in one or more implementations, the camera parameters 512 may include parameters for multiple vehicle configurations, including, as examples, for multiple positions of the side mirrors 106 (e.g., an extended position and a folded position). As one illustrative example, the camera parameters 512 may include two lookup tables (e.g., one for each of two mirror configurations) for transformations between pixel locations in image space and physical locations in the external environment, and the sensing block 506 may select the lookup table based on a current configuration of the side mirrors 106. In this example, transforming the particular location 408 in the image 400 that corresponds a portion of the vehicle 300 into the physical location 518 in the external environment 204 using the camera parameters 512 of the camera 104 that captured the image 400 may include transforming the location based on a determination of whether the side mirror 106 of the vehicle 100 is in a folded position or an extended position.

As illustrated in FIGS. 3-6, in one or more implementations, the processing circuitry 108 of the vehicle 100 may be configured to detect the vehicle 300 in the image 400, in part, by providing the image 400 to a neural network (e.g., object detector 502) that has been trained to detect at least vehicles in images; and detecting the vehicle based on an output (e.g., bounding box 404) of the neural network. In one or more implementations, detecting the vehicle may include determining, by the neural network, that the vehicle is not a person. In one or more implementations an output of the neural network may include a bounding box 404 corresponding to an object (e.g., vehicle 300) in the image 400, a classification (e.g., CLASS1) of the object as the vehicle, and an object identifier (ID1) associated with the object.

In one or more implementations, the processing circuitry 108 of the vehicle 100 may be configured to determine that at least a portion of the vehicle is within the threshold distance, D, of the vehicle 100 by transforming a location (e.g., particular location 408) in the image 400 that corresponds to at least the portion of the vehicle into a physical location (e.g., physical location 518) in the external environment 204, using one or more known parameters (e.g., camera parameters 512) of at least one of the cameras 104. In one or more implementations, the location in the image that corresponds to at least the portion of the vehicle may include a predetermined location on the bounding box. In one or more implementations, the processing circuitry 108 of the vehicle 100 may be configured to determine that the vehicle 300 that is within the threshold distance of the vehicle 100 is moving based on multiple detections of the object having the object identifier (e.g., ID1) in multiple images (e.g., tracked by multi-object tracking block 519) from one or more of the cameras 104.

For example, the neural network (e.g., object detector 502) may be configured to output multiple bounding boxes, including the bounding box 404, for the multiple detections of the object, and the processing circuitry 108 may be configured to determine that the vehicle that is within the threshold distance of the apparatus is moving based on a change in location of the bounding box and/or based on a change in a shape of the bounding box, as discussed herein.

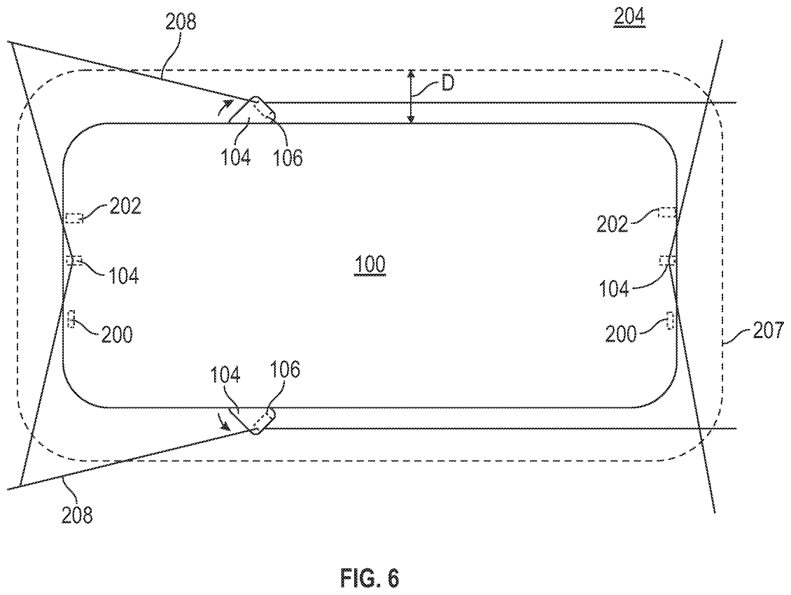

FIG. 7 illustrates a flow diagram of an example process for recording an actual or potential impact to a vehicle, in accordance with implementations of the subject technology. For explanatory purposes, the process 700 is primarily described herein with reference to the vehicle 100, the camera(s) 104, and the processing circuitry 108 of FIGS. 1A-3. However, the process 700 is not limited to the vehicle 100, the camera(s) 104, and the processing circuitry 108 of FIGS. 1A-3, and one or more blocks (or operations) of the process 700 may be performed by one or more other components of other suitable moveable apparatuses, devices, or systems. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

As illustrated in FIG. 700, at block 702, a vehicle (e.g., vehicle 300) may be detected (e.g., by the processing circuitry 108, such as by the object detector 502) in at least one image (e.g., image 400) from at least one of a plurality of cameras (e.g., cameras 104) that are mounted to an apparatus (e.g., vehicle 100). For example, detecting the vehicle in the at least one image may include providing the at least one image to a neural network (e.g., object detector 502) that has been trained to detect at least vehicles in images; and detecting the vehicle based on an output (e.g., bounding box 404) of the neural network (e.g., based on classification of an object in the at least one image as a vehicle, such as with a confidence above a confidence threshold).

In one or more implementations, determining that at least the portion of the vehicle is within the threshold distance of the apparatus may include transforming (e.g., by the processing circuitry 108 of the vehicle 100, such as by the sensing block 506, such as by the transformation block 516) a location (e.g., particular location 408) in the at least one image that corresponds to the at least the portion of the vehicle into a physical location (e.g., physical location 518) in the external environment using one or more known parameters (e.g., camera parameters 512) of the at least one of the plurality of cameras. The output of the neural network may include a bounding box (e.g., bounding box 404) corresponding to an object (e.g., vehicle 300) in the at least one image, a classification (e.g., CLASS1) of the object as the vehicle, and an object identifier (e.g., ID1) associated with the object. The object identifier may be separate from one or more physical identifiers of the object that may be included in the at least one image. The location in the at least one image that corresponds to the at least the portion of the vehicle may include a predetermined location (e.g., the bottom center or another location) on the bounding box.

At block 704, responsive to detecting the vehicle, it may be determined (e.g., by the vehicle 100, such as by the processing circuitry 108, such as by the sensing block 506) that at least a portion of the vehicle is within a threshold distance (D) of the apparatus (e.g., as described in FIG. 5).

At block 706, responsive to determining that at least the portion of the vehicle is within the threshold distance of the apparatus, it may be determined (e.g., by the vehicle 100, such as by the processing circuitry 108, such as by the motion detection block 508) that the vehicle that is within the threshold distance of the apparatus is moving. For example, determining that the vehicle that is within the threshold distance of the apparatus is moving may include determining (e.g., by the processing circuitry 108, such as by the frame group motion detector 524 and/or the motion confirmation block 525) that the vehicle that is within the threshold distance of the apparatus is moving based on multiple detections of the object having the object identifier in multiple images from one or more of the plurality of cameras.

At block 708, responsive to determining that the vehicle that is within the threshold distance of the apparatus is moving (e.g., responsive to the output 526 of the motion detection block 508), recording (510) of a video of an external environment (e.g., external environment 204) of the apparatus may be initiated using the plurality of cameras. Recording the video may include storing video frames captured by one or more (e.g., all) of the cameras of the apparatus during a period of time during which the vehicle is detected within the threshold distance. For example, the recording may include storing video frames for a period of time (e.g., several seconds) before the determination that the vehicle is within the threshold distance, and or storing subsequent video frames captured during a period of time after the determination that the vehicle is within the threshold distance (e.g., a predetermined period of time, until the vehicle is no longer detected in the images from the cameras, and/or until a vehicle identifier 304 has been captured in one or more of the video frames).

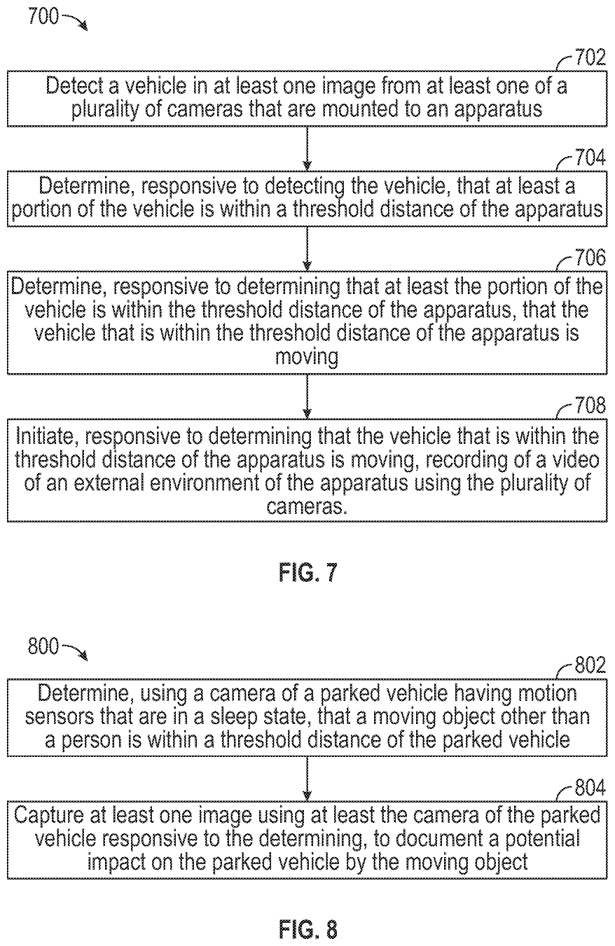

FIG. 8 illustrates a flow diagram of another example process for recording an impact to a vehicle, in accordance with implementations of the subject technology. For explanatory purposes, the process 800 is primarily described herein with reference to the vehicle 100, the camera(s) 104, and the processing circuitry 108 of FIGS. 1A-3. However, the process 800 is not limited to the vehicle 100, the camera(s) 104, and the processing circuitry 108 of FIGS. 1A-3, and one or more blocks (or operations) of the process 800 may be performed by one or more other components of other suitable moveable apparatuses, devices, or systems. Further for explanatory purposes, some of the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

As illustrated in FIG. 800, at block 802, it may be determined (e.g., by processing circuitry 108), using a camera (e.g., camera 104) of a parked vehicle (e.g., vehicle 100) having motion sensors (e.g., motion sensors 200) that are in a sleep state, that a moving object (e.g., vehicle 300), other than a person, is within a threshold distance (D) of the parked vehicle (e.g., as described herein in connection with FIG. 5). The sleep state may include any inactive state of the motion sensors, such as a low power state or an off state in which the motion sensors are not generating and/or not outputting sensor data or sensor signals.

At block 804, at least one image (e.g., one or more video frames, such as image 400, and/or one or more additional images, also referred to herein as video frames) may be captured (e.g., by the processing circuitry 108) using at least the camera of the parked vehicle responsive to the determining, such as to document a potential impact (e.g., an impact that has already occurred or an impending impact) on the parked vehicle by the moving object. In one or more implementations, capturing the at least one image may include capturing an image of an identifier (e.g., vehicle identifier 304) of the moving object. The identifier of the moving object may be a physical entity in the external environment 204, and may be distinct from an identifier of a bounding box corresponding to the moving object or another electronic identifier of an image of the object. For example, the moving object may include a moving vehicle and the identifier of the object may include a license plate of the moving vehicle.

In one or more implementations, the parked vehicle also includes proximity sensors (e.g., proximity sensors 202) that are in the sleep state, and the process 800 may also include determining, using the camera of the parked vehicle having the motion sensors and the proximity sensors that are in the sleep state, that the moving object other than the person is within the threshold distance of the parked vehicle by performing a geometric determination of a location of the moving object without identifying individual features (e.g., headlights, bumpers, doors, windows, wheels, etc.) of the object. For example, the geometric determination may include transforming (e.g., by transformation block 516) a location in image space (e.g., a particular location 408 on a bounding box 404 corresponding to the moving object) to a location in physical space, such as using one or more known (e.g., previously stored) camera parameters (e.g., camera parameters 512) for the camera of the parked vehicle.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. An apparatus, comprising:
a plurality of cameras, each camera having a field of view that includes a respective portion of an external environment of the apparatus; and
processing circuitry configured to initiate recording of a video of the external environment using the plurality of cameras based on:
a detection of a vehicle in at least one image from at least one of the plurality of cameras;
a determination that at least a portion of the vehicle is within a threshold distance of the apparatus; and
a determination that the vehicle that is within the threshold distance of the apparatus is moving.

2. The apparatus of claim 1, wherein the plurality of cameras and the processing circuitry are implemented in another vehicle that is parked, and wherein the processing circuitry is configured to initiate the recording of the video of the external environment to capture a hit-and-run incident involving the vehicle.

3. The apparatus of claim 1, wherein the processing circuitry is configured to detect the vehicle in the at least one image by:
providing the at least one image to a neural network that has been trained to detect at least vehicles in images; and
detecting the vehicle based on an output of the neural network.

4. The apparatus of claim 3, wherein detecting the vehicle comprises determining that the vehicle is not a person.

5. The apparatus of claim 3, wherein the output of the neural network comprises a bounding box corresponding to an object in the at least one image, a classification of the object as the vehicle, and an object identifier associated with the object.

6. The apparatus of claim 5, wherein the processing circuitry is configured to determine that at least the portion of the vehicle is within the threshold distance of the apparatus by transforming a location in the at least one image that corresponds to the at least the portion of the vehicle into a physical location in the external environment, using one or more known parameters of the at least one of the plurality of cameras.

7. The apparatus of claim 6, wherein the location in the at least one image that corresponds to the at least the portion of the vehicle comprises a predetermined location on the bounding box.

8. The apparatus of claim 7, wherein the processing circuitry is configured to determine that the vehicle that is within the threshold distance of the apparatus is moving based on multiple detections of the object having the object identifier in multiple images from one or more of the plurality of cameras.

9. The apparatus of claim 8, wherein the neural network is configured to output multiple bounding boxes, including the bounding box, for the multiple detections of the object, and wherein the processing circuitry is configured to determine that the vehicle that is within the threshold distance of the apparatus is moving based on a change in location of the bounding box.

10. The apparatus of claim 8, wherein the neural network is configured to output multiple bounding boxes, including the bounding box, for the multiple detections of the object, and wherein the processing circuitry is configured to determine that the vehicle that is within the threshold distance of the apparatus is moving based on a change in a shape of the bounding box.

11. The apparatus of claim 6, wherein the at least one of the plurality of cameras is mounted to a side mirror of a vehicle, and wherein transforming the location in the at least one image that corresponds to the at least the portion of the vehicle into the physical location in the external environment using the one or more known parameters of the at least one of the plurality of cameras comprises transforming the location in the at least one image that corresponds to the at least the portion of the vehicle into the physical location in the external environment using the one or more known parameters of the at least one of the plurality of cameras and based on a determination of whether the side mirror of the vehicle is in a folded position or an extended position.

12. A method, comprising:
detecting a vehicle in at least one image from at least one of a plurality of cameras that are mounted to an apparatus;
determining, responsive to detecting the vehicle, that at least a portion of the vehicle is within a threshold distance of the apparatus;
determining, responsive to determining that at least the portion of the vehicle is within the threshold distance of the apparatus, that the vehicle that is within the threshold distance of the apparatus is moving; and
initiating, responsive to determining that the vehicle that is within the threshold distance of the apparatus is moving, recording of a video of an external environment of the apparatus using the plurality of cameras.

13. The method of claim 12, wherein detecting the vehicle in the at least one image comprises:
providing the at least one image to a neural network that has been trained to detect at least vehicles in images; and
detecting the vehicle based on an output of the neural network.

14. The method of claim 13, wherein determining that at least the portion of the vehicle is within the threshold distance of the apparatus comprises transforming a location in the at least one image that corresponds to the at least the portion of the vehicle into a physical location in the external environment using one or more known parameters of the at least one of the plurality of cameras.

15. The method of claim 14, wherein the output of the neural network comprises a bounding box corresponding to an object in the at least one image, a classification of the object as the vehicle, and an object identifier associated with the object, and wherein the location in the at least one image that corresponds to the at least the portion of the vehicle comprises a predetermined location on the bounding box.

16. The method of claim 15, wherein determining that the vehicle that is within the threshold distance of the apparatus is moving comprises determining that the vehicle that is within the threshold distance of the apparatus is moving based on multiple detections of the object having the object identifier in multiple images from one or more of the plurality of cameras.

17. A method, comprising:
determining, using a camera of a parked vehicle having motion sensors that are in a sleep state, that a moving object other than a person is within a threshold distance of the parked vehicle; and
capturing at least one image using at least the camera of the parked vehicle responsive to the determining, to document a potential impact on the parked vehicle by the moving object.

18. The method of claim 17, wherein capturing the at least one image comprises capturing an image of an identifier of the moving object.

19. The method of claim 18, wherein the moving object comprises a moving vehicle and wherein the identifier of the object comprises a license plate of the moving vehicle.

20. The method of claim 17, wherein the parked vehicle further comprises proximity sensors that are in the sleep state, and wherein the method further comprises determining, using the camera of the parked vehicle having the motion sensors and the proximity sensors that are in the sleep state, that the moving object other than the person is within the threshold distance of the parked vehicle by performing a geometric determination of a location of the moving object without identifying individual features of the object.
